(19) United States
(12) Patent Application Publication
(10) Pub. No.: US 2023/0141792 A1
(43) Pub. Date: May 11, 2023

(54) PROCESS FOR REDUCING ALDEHYDE EMISSIONS IN POLYETHER POLYOLS AND POLYURETHANE FOAMS

(71) Applicant: Dow Global Technologies LLC, Midland, MI (US)

(72) Inventors: Wenbin BAO, Shanghai (CN); Shaoguang Feng, Shanghai (CN); Haiying Li, Shanghai (CN); Ping Zhang, Shanghai (CN); Zhengming Tang, Shanghai (CN); Jian Zou, Shanghai (CN); Jie Ji, Shanghai (CN)

(21) Appl. No.: 17/907,910

(22) PCT Filed: Mar. 12, 2020
(86) PCT No.: PCT/CN2020/078948

§ 371 Date: Aug. 29, 2022

(51) Int. Cl. C08L 75/08; C08G 18/10; C08G 18/48; C08G 18/32; C08G 18/66

(52) U.S. Cl. CPC C08L 75/08; C08G 18/10; C08G 18/4883; C08G 18/4829; C08G 18/4816; C08G 18/3206; C08G 18/6677

(57) ABSTRACT

Polyurethane foams are made by curing a reaction mixture that contains an aromatic polyisocyanate, at least one iso-cyanate-reactive material having an average functionality of at least 2 and an equivalent weight of at least 200 per isocyanate-reactive group, at least one blowing agent, at least one surfactant and at least one catalyst, a certain β-diketone compound and a water-soluble amino-functional polymer. Foams so produced emit low levels of aldehydes.

This invention relates to polyether polyols and polyurethanes that exhibit low levels of aldehydes, and to methods for producing such polyurethanes. Polyurethane foams are used in many office, household and vehicular applications.

They are used, for example, in appliance applications and as cushioning for bedding and furniture. In automobiles and trucks, polyurethanes are used as seat cushioning, in headrests, in dashboards and instrument panels, in armrests, in headliners, noise, vibration and harshness abatement measures, as acoustical abatement measures, and other applications.

These polyurethanes often emit varying levels of aldehydes such as formaldehyde, acetaldehyde and propionaldehyde. Because of the cellular structure of these foams, aldehydes contained in the foam easily escape into the atmosphere. This can present an odor concern and an exposure concern, especially when people or animals are exposed to the material within an enclosed space. Vehicle manufacturers are imposing stricter limits on the emissions from materials that are used in the passenger cabins of cars, trucks, buses, trains and aircraft.

Scavengers are sometimes used to reduce aldehyde emissions from various types of materials. In the polyurethane field, there is, for example, WO 2006/111492, which describes adding antioxidants and hindered amine light stabilizers (HALS) to polyols to reduce aldehydes. WO 2009/114329 describes treating polyols with certain types of aminoalcohols and treating polyisocyanates with certain nitroalkanes, in order to reduce aldehydes in the polyols and polyisocyanates, respectively, and in polyurethanes made from those materials. JP 2005-154599 describes the addition of an alkali metal borohydride to a polyurethane formulation for that purpose. U.S. Pat. No. 5,506,329 describes the use of certain aldimine oxazolidine compounds for scavenging formaldehyde from polyisocyanate-containing preparations, and describes nitroalkanes and aminoalcohols as formaldehyde scavengers in textile and plywood applications. EP 1428847A describes using various polyamine compounds to scavenge formaldehyde.

These approaches provide limited benefit, in part because aldehydes present in polyurethane foam are not always carried in from the raw materials used to make the foam. Formaldehyde and acetaldehyde in particular can form during the curing step or when the foam is later subjected to UV light, elevated temperatures or other conditions. WO 2018/148898 describes the use of aminoalcohols together with certain antioxidants to reduce aldehyde emissions from polyurethane foam. This combination provides some improvement, but a greater reduction of aldehyde emissions is wanted.

Certain acetoacetamide compounds are described as aldehyde scavengers for polyurethane foam in U.S. Pat. No. 10,196,493 and US Published Patent Application No. 2019-0119460. Certain cyclic 13-diketones are described as aldehyde scavengers in PCT/CN19/103566.

A method for effectively and economically reducing aldehyde emissions is wanted. Preferably, this method does not result in a significant change in the properties or performance of the polyurethane.

This invention is a process for producing a polyurethane foam comprising forming a reaction mixture that contains an aromatic polyisocyanate, at least one isocyanate-reactive material having an average functionality of at least 2 and an equivalent weight of at least 200 grams per mole of isocyanate-reactive groups, at least one blowing agent, at least one surfactant and at least one catalyst, and curing the reaction mixture to form the polyurethane foam, wherein the curing is performed in the presence of (i) at least one β-diketone compound, wherein the β-diketone compound is a compound represented by structure I:

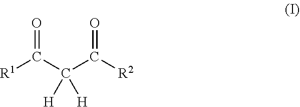

wherein R¹ and R² are independently selected from hydrogen, —NH₂, —NH—R³—N(R⁴)₂, —OR⁴ and —R⁴, wherein each R³ and R⁴ is independently unsubstituted hydrocarbon or hydrocarbon substituted with one or more of O, N, S, P or halogen, with the proviso that R¹ and R² together may form a divalent radical and further provided that at least one of R¹ and R² is not hydrogen, and (ii) at least one water-soluble, amino-functional polymer having a number average molecular weight of at least 300 and at least 3 primary and/or secondary amino groups per molecule.

The invention is also a process for reducing aldehyde emissions from a polyurethane foam, comprising: a) combining

at least one β-diketone compound is a compound represented by structure I:

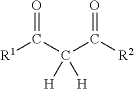

wherein R¹ and R² are independently selected from hydrogen, —NH₂, —NH—R³—N(R⁴)₂, —OR⁴ and —R⁴, wherein each R³ and R⁴ is independently unsubstituted hydrocarbon or hydrocarbon substituted with one or more of O, N, S, P or halogen, with the proviso that R¹ and R₂ together may form a divalent radical and further provided that at least one of R¹ and R² is not hydrogen, and

(ii) at least one water-soluble, amino-functional polymer having a number average molecular weight of at least 300 and at least 3 primary and/or secondary amino groups per molecule,

with at least one isocyanate-reactive material having an average functionality of at least 2 and an equivalent weight of at least 200 grams per mole of isocyanate-reactive groups to form a mixture and then b) combining the mixture from step a) with at least one organic polyisocyanate and curing the resulting reaction mixture in the presence of at least one blowing agent, at least one surfactant and at least one catalyst to form a polyurethane foam.

The invention is also a polyurethane foam made in either of the foregoing processes.

The invention is also a process for reducing aldehyde emissions from a polyether polyol, comprising combining 0.01 to 5 parts by weight of at least one β-diketone compound and 0.01 to 5 parts by weight of at least one water-soluble, amino-functional polymer having a number average molecular weight of at least 300 and at least 3 primary and/or secondary amino groups per molecule with 100 parts by weight of the polyether polyol, wherein the β-diketone compound is represented by structure I:

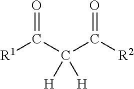

wherein R¹ and R² are independently selected from hydrogen, —NH₂, —NH—R³—N(R⁴)₂, —OR⁴ and —R⁴, wherein each R³ and R⁴ is independently unsubstituted hydrocarbon or hydrocarbon substituted with one or more of O, N, S, P or halogen, with the proviso that R¹ and R² together may form a divalent radical and further provided that at least one of R¹ and R² is not hydrogen.

The invention is also a polyether polyol having a hydroxyl equivalent weight of at least 200 grams per equivalent of hydroxyl groups, which polyether polyol contains 0.01 to 5 parts by weight of at least one β-diketone compound and 0.01 to 5 parts by weight of at least one water-soluble, amino-functional polymer having a number average molecular weight of at least 300 and at least 3 primary and/or secondary amino groups per molecule with 100 parts by weight of the polyether polyol, wherein the β-diketone compound is represented by structure I:

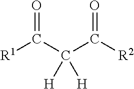

wherein R¹ and R² are independently selected from hydrogen, —NH₂, —NH—R³—N(R⁴)₂, —OR⁴ and —R⁴, wherein each R³ and R⁴ is independently unsubstituted hydrocarbon or hydrocarbon substituted with one or more of O, N, S, P or halogen, with the proviso that R¹ and R² together may form a divalent radical and further provided that at least one of R¹ and R² is not hydrogen.

The presence of both of the β-diketone compound and the water-soluble, amino-functional polymer has been found to reduce the levels of aldehydes emitted by the polyurethane foam and by the polyether polyol. The performance of the combination is much superior to that expected from the performances of the β-diketone compound and amino-functional polymer by themselves. In some embodiments, the β-diketone compound has the further advantage of being reactive toward isocyanate groups. As such, it reacts during the curing step to become incorporated into the polyurethane polymer structure. This further reduces emissions of organic compounds. At least some of the β-diketone compounds of structure I are resistant to hydrolysis, which reduces the generation and potential emission of volatile hydrolysis by-products.

In structure I, each R³ and R⁴ may independently be aromatic, aliphatic, alicyclic or any combination thereof. R³ and R⁴ may be independently substituted with O, N, S, P or halogen atoms. Oxygen-containing substituents may be, for example, carbonyl, hydroxyl, ester, carbonate or ether groups. Each R⁴ preferably has up to 50 carbon atoms, more preferably up to 10 carbon atoms, up to 6 carbon atoms or up to 4 carbon atoms. R³, when present, preferably has up to 10, up to 6, up to 4 or up to 2 carbon atoms. In specific embodiment, each R⁴ may be independently alkyl such as methyl, ethyl, propyl, butyl, pentyl, hexyl and the like (including any isomers of any of the foregoing); cyclohexyl; alkyl-substituted cyclohexyl; phenyl and alkyl-substituted phenyl, in each case preferably having up to 10, especially up to 6 carbon atoms.

In some embodiments R¹ and R² together form a divalent radical, in which case the β-diketone compound is a cyclic compound in which a —C(O)—CH₂—C(O)— moiety forms part of a ring structure together with the divalent radical formed by R¹ and R².

The β-diketone compound preferably has a molecular weight of up to 290 g/mol, more preferably up to 250 g/mol.

In some embodiments, the β-diketone compound is an acetoacetate ester or amide is characterized by having one or more acetoacetate ester or acetoacetate amide groups having structure II:

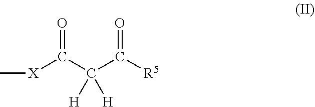

wherein R⁵ is a substituted or unsubstituted C₁-C₆ alkyl or a substituted or unsubstituted aryl group, preferably a C₁ or C₂ alkyl group and X is —O— in the case of an ester and —NH—, in the case of an amide. R⁵ is most preferably methyl. The acetoacetate ester or amide may have two or more such acetoacetate ester or amide groups. Among the suitable acetoacetate esters and acetoacetate amides are those represented by structure II:

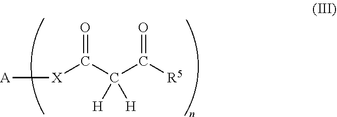

wherein A is a linking group, n is at least 1 and R⁵ and X are as described with regard to structure II. A may be, for example, a C₁-C₃₀ linear or branched, unsubstituted or substituted alkyl, aryl, arylalkyl, alkaryl group, wherein the substituents optionally may be or include or more of O, N, S, P or halogen. Oxygen-containing substituents may be, for example, carbonyl, hydroxyl, ester, carbonate or ether groups. n may be, for example, 1 to 100, 1 to 20, 1 to 10 or 1 to 4. n is preferably at least 2 when X is oxygen.

Useful acetoacetate compounds include those described in JP 2005-06754A, JP 2005-179423A and US Publication No. 2016/0304686.

In some embodiments, X in structure III is oxygen, n is at least 2 and A is the residue of a polyalcohol after removal of one or more —OH groups. The acetoacetate compound in such a case is an acetoacetate ester or polyester of an alcohol having the form A(OH)ₓ, where x is equal to or greater than n. Examples of acetoacetate esters include mono- and polyacetoacetate esters of polyols such as ethylene glycol, 1,2-propylene glycol, 1,3-propylene glycol, 1,4-butane diol, 1,6-hexane diol, glycerin, trimethylolpropane, trimethylolethane, trimethoxymethane, erythritol, pentaerythritol, diethylene glycol, triethylene glycol, dipropylene glycol, tripropylene glycol, sorbitol, mannitol, glucose, fructose, sucrose, 1,2,3,4,5,6-hexahydroxy-n-hexane, and the like.

Specific acetoacetate ester compounds include, for example, trimethylolpropane mono-, di or triacetoacetate ester, trimethylolethane mono-, di- or tri acetoacetate ester, trimethoxymethane mono-, di- or triacetoacetate ester; ethylene glycol mono- or diacetoacetate ester; 1,2-propylene glycol mono- or diacetoacetate ester, 1,3-propylene glycol mono- or diacetoacetate ester, pentaerythritol mono-, di-, tri- or tetraacetoacetate ester, glycerin mono-, di or triacetoacetate ester, diethylene glycol mono- or diacetoacetate ester, dipropylene glycol mono- or diacetoacetate ester, triethylene glycol mono- or diacetoacetate ester, erythritol mono-, di-, tri- or tetraacetoacetate ester, n-hexane mono-, di, tri, tetra, penta-, or hexaacetoacetate ester, sorbitol mono-, di-, tri-, tetra-, penta- or hexaacetoacetate ester and 1,4-butanediol mono- or diacetoacetate ester.

In some embodiments, X in structure III is —NH—, n is one or more and A is the residue of an amine or polyamine after removal of one or more —NH₂ groups. The acetoacetate compound in such a case is an acetoacetate amide or polyamide of an amine having the form A(NH₂)ₓ, where x is equal to or greater than n. An example of such an amide compound is

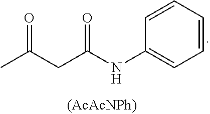

In specific embodiments, the β-diketone compound is a 3-oxopropanamide compound represented by structure IV:

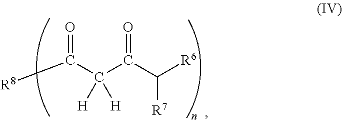

wherein R⁸ is hydrogen or a hydrocarbon group, R⁶ is hydrogen, hydrocarbon, hydroxyalkyl or aminoalkyl, R⁷ is hydroxyalkyl or aminoalkyl, and n is at least 1. In some embodiments, R⁶ is hydrogen or an aminoalkyl or hydroxyalkyl group having up to 6, preferably 2 to 4, carbon atoms. R⁶ is most preferably hydrogen. R⁷ is preferably hydroxyalkyl having up to 6, especially 2 to 4, carbon atoms. R⁷ is most preferably 2-hydroxyethyl (—CH₂—CH₂—OH) or 2-hydroxypropyl (—CH₂—CH(CH₃)—OH). n is preferably 1 to 6, more preferably 1 to 4. In specific embodiments, n may be 1, 2, 3 or 4. n is most preferably 1.

In some embodiments, R⁸ is phenyl or alkyl having up to 6 carbon atoms, R⁶ is hydrogen, R⁷ is 2-hydroxyethyl or 2-hydroxypropyl and n is 1. A particularly preferred 3-oxopropanamide is N-(2-hydroxyethyl)-3-oxobutanamide, which corresponds to structure IV in which R⁸ is methyl, R⁶ is hydrogen, R⁷ is 2-hydroxyethyl and n is 1.

In still other embodiments, the β-diketone compound is a cyclic compound characterized in having at least one:

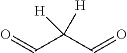

moiety as part of a ring. The ring may contain, for example, 4, 5 or 6 ring atoms. The ring atoms (other than the atoms of 1,3-diketone structure that form part of the ring) may be, for example, carbon, nitrogen and/or oxygen atoms.

Among the suitable cyclic β-diketone compounds are those represented by the structure

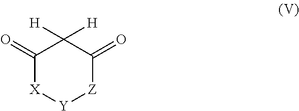

wherein X, Y, Z are independently carbonyl, —C(R⁹R¹⁰)—, —NR¹¹—, —O— or a chemical bond. Each R⁹ and R¹⁰ are independently H, a substituted or unsubstituted linear or branched alkyl or alkylene group having 1 to 10 carbon atoms, a substituted or unsubstituted phenyl group, a halogen, —CO₂CH₃, or —CN, with the proviso that any two or more of R⁹ and R¹⁰ may be connected intra- or inter-molecularly and each R¹¹ is independently H, a substituted or unsubstituted linear or branched alkyl or alkylene group having 1 to 10 carbon atoms or a substituted or unsubstituted phenyl group. Substituents on the R⁹, R¹⁰ and R¹¹ groups optionally may include N, O, S, P and/or halogen atoms.

Other suitable cyclic β-diketone s are represented by structure VI:

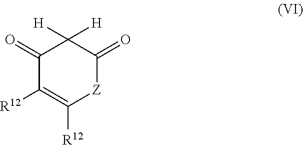

wherein Z is carbonyl, —C(R¹³R¹⁴)—, —NR¹⁵—, —O— or a chemical bond, each R¹², R¹³ and R¹⁴ is independently H, a substituted or unsubstituted linear or branched alkyl or alkenyl group having 1 to 10 carbon atoms, a substituted or unsubstituted phenyl group, a halogen, —CO₂CH₃, or —CN, with the proviso that any two or more of R¹², R¹³ and R¹⁴ may be connected intra- or inter-molecularly and each R¹⁵ is independently H, a substituted or unsubstituted linear or branched alkyl or alkenyl group having 1 to 10 carbon atoms or a substituted or unsubstituted phenyl group.

R¹², R¹³, R¹⁴ and R¹⁵, when substituted with heteroatoms, preferably are substituted with only nitrogen and/or oxygen atoms. Oxygen substituents may be, for example, ether, carboxyl or hydroxyl oxygens. Nitrogen substituents may be primary or secondary amino, imido or amido nitrogens.

Specific cyclic β-diketones include, for example, cyclohexane-1,3,5-trione, 1,3-cyclohexanedione, pyrazolidine-3,5-dione, 1,2 -dimethylpyrazolidine-3,5-dione, 1-methylpyrazolidine-3,5-dione, 1,1-dimethyl-cyclopentan-2,4-dione, 1-ethyl-cyclohexan-2,4-dione, 1,1-diethyl-cyclohexan-3,5-dione, 6-methyl-pyran-2,4-dione, 6-ethyl-pyran-2,4-dione, 6-isopropyl-pyran-2,4-dione, 6-(n)-butyl-pyran-2,4-dione, 6-isobutyl-pyran-2,4-dione, 6-pentyl-pyran-2,4-dione, 6-isopentyl-pyran-2,4-dione, 6,7-dihydrocyclopenta[b]pyran-2,4(3H, 5H)-dione, 5,6,7,8-tetrahydro-chroman-2,4-dione, chroman-2,4-dione, 6-trans-propenyl-dihydro-pyran-2,4-dione, 1-oxaspiro- [5,5]-undecan-2,4-dione, 2,2-dipropyl- [1,3]-dioxan-4,6-dione, 2-phenyl-[1,3]-dioxan-4,6-dione, 6,10-dioxa-spiro-[4,5]-decan-7,9-dione, 1,5-dioxa-spiro-[5, 5]-undecan-2,4-dione, 1-methyl-2,4,6-trioxo-hexahydro-pyrimidine, 1-ethyl-2,4,6-trioxo-hexahydro-pyrimidine, 1-phenyl-2,4,6-trioxo-hexahydro-pyrimidine, s-indacene-1,3,5,7(2H, 6H)-tetraone, furan-2,4(3H, 5H)-dione, 3,3′-(hexane-1,1-diyl)bis(1-methylpyrimidine-2,4,6(1H, 3H, 5H)-trione), 2,2-dimethyl-1,3-dioxane-4,6-dione, furan-2,4(3H, 5H)-dione, pyrimidine-2,4,6(1H, 3H, 5H)-trione and 1,3-dimethylpyrimidine-2,4,6(1H, 3H, 5H)-trione.

The water-soluble, amino-functional polymer has a number average molecular weight of at least 300 g/mol. The molecular weight may be at least 500 g/mol and may be up to, for example, 1,000,000 g/mol, up to 500,000 g/mol, up to 250,000 g/mol, up to 100,000 g/mol, up to 25,000 g/mol, up to 10,000 g/mol, up to 5,000 g/mol or up to 2,000 g/mol. The water-soluble amino-functional polymer has at least 3 primary and/or secondary amino groups per molecule. It may contain at least 5, at least 10, at least 20 or at least 50 primary and/or secondary amino groups, and may contain as many as 20,000 primary and/or secondary amino groups. The molecular weight per amino group may be, for example, at least 40 or at least 50, and may be, for example, up to 500, up to 300 or up to 250.

Useful water-soluble amino-functional polymers include homopolymers and copolymer of vinyl amine, crosslinked polyamidoamines, crosslinked polyamidoamines grafted with ethyleneimine, polyethyleneimines, alkoxylated polyethyleneimines, crosslinked polyethyleneimines, amidated polyethyleneimines, alkylated polyethyleneimines, amine-epichlorohydrin polycondensates, water-soluble polyadducts made from multifunctional epoxides and multifunctional amines, alkoxylated polyamines, polyallylamines, and condensates of lysine, ornithine or arginine or mixtures of any two or more thereof. Suitable water-soluble amino-functional polymers are described, for example, in EP 1 428 847 A.

A preferred water-soluble, amino-functional polymer is a polyethyleneimine. Polyethyleneimines can by made by polymerizing ethyleneimine in aqueous solution in the presence of a catalyst.

To produce foam in accordance with the invention, at least one polyisocyanate is reacted with at least one isocyanate-reactive compound that has a functionality of at least 2 and an equivalent weight of at least 200 gram per mole of isocyanate-reactive groups. Other ingredients may be present as discussed hereinbelow. The reaction is performed in the presence of a β-diketone compound of structure I and the water-soluble, amino-functional polymer.

A suitable amount of β-diketone compound is 0.01 to 5 pph (i.e., 0.01 to 5 parts by weight per 100 parts by weight of isocyanate reactive compound(s) that have at least two isocyanate-reactive groups per molecule and an equivalent weight of at least 200 per isocyanate-reactive group). A preferred minimum amount is at least 0.1 or at least 0.2 pph and a preferred maximum amount is up to 2.5, up to 1.5, up to 1, up to 0.75 or up to 0.5 pph.

A suitable amount of water-soluble, amino-functional polymer is 0.01 to 2 pph (i.e., 0.01 to 2 parts by weight per 100 parts by weight of isocyanate reactive compound(s) that have at least two isocyanate-reactive groups per molecule and an equivalent weight of at least 200 per isocyanate-reactive group). A preferred minimum amount is at least 0.025 or at least 0.04 pph and a preferred maximum amount is up to 1, up to 0.5, up to 0.25 or up to 0.1 0 pph.

The β-diketone compound and water-soluble, amino-functional polymer can be provided as a mixture with any one or more of the various ingredients of the formulation used to produce the foam. Alternatively, they each may be added into the reaction as a separate component or stream without being previously combined with any of the other ingredients.

Preferably, however, the β-diketone compound and water-soluble, amino-functional polymer is blended with the isocyanate reactive compound(s) that have at least two isocyanate-reactive groups per molecule and an equivalent weight of at least 200 grams per mole of isocyanate-reactive groups, prior to forming the polyurethane foam. The isocyanate-reactive compound(s) preferably include at least one polyether polyol. The resulting blend may be maintained at approximately room temperature or a higher temperature (but below the boiling temperature of the β-diketone compound and below the temperature at which the polyol degrades) for a period of at least 30 minutes prior to making the foam. Such a blend may be maintained under such conditions for any arbitrarily longer time, such as up to a month, up to a week, or up to a day.

The foam formulation includes at least one isocyanate-reactive compound that has a functionality of at least 2 and an equivalent weight of at least 200 grams per mole of isocyanate-reactive groups. “Functionality” refers to the average number of isocyanate-reactive groups per molecule. The functionality may be as much as 8 or more but preferably is from 2 to 4. The isocyanate groups may be, for example, hydroxyl, primary amino and/or secondary amino groups, but hydroxyl groups are preferred. The equivalent weight may be up to 6000 or more, but is preferably from 500 to 3500 and more preferably from 1000 to 2500. This isocyanate-reactive compound may be, for example, a polyether polyol, a polyester polyol, a hydroxyl-terminated butadiene polymer or copolymer, a hydroxyl-containing acrylate polymer, and the like. A preferred type of isocyanate-reactive compound is a polyether polyol, especially a polymer of propylene oxide or a copolymer of propylene oxide and ethylene oxide. A copolymer of propylene oxide and ethylene oxide may be a block copolymer having terminal poly(oxyethylene) blocks and in which at least 50% of the hydroxyl groups are primary. Another suitable copolymer of propylene oxide and ethylene oxide may be a random or pseudo-random copolymer, which may also contain terminal poly(oxyethylene) blocks and in which at least 50% of the hydroxyl groups are primary.

Polyester polyols that are useful as the isocyanate-reactive compound include reaction products of polyols, preferably diols, with polycarboxylic acids or their anhydrides, preferably dicarboxylic acids or dicarboxylic acid anhydrides. The polycarboxylic acids or anhydrides may be aliphatic, cycloaliphatic, aromatic and/or heterocyclic and may be substituted, such as with halogen atoms. The polycarboxylic acids may be unsaturated. Examples of these polycarboxylic acids include succinic acid, adipic acid, terephthalic acid, isophthalic acid, trimellitic anhydride, phthalic anhydride, maleic acid, maleic acid anhydride and fumaric acid. The polyols used in making the polyester polyols preferably have an equivalent weight of about 150 or less and include ethylene glycol, 1,2- and 1,3-propylene glycol, 1,4- and 1,3-butane diol, 1,6-hexane diol, 1,8-octane diol, neopentyl glycol, cyclohexane dimethanol, 2-methyl-1,3-propane diol, glycerine, trimethylolpropane, 1,2,6-hexane triol, 1,2,4-butane triol, trimethylolethane, pentaerythritol, quinitol, mannitol, sorbitol, methyl glycoside, diethylene glycol, triethylene glycol, tetraethylene glycol, dipropylene glycol, dibutylene glycol and the like. Polycaprolactone polyols such as those sold by The Dow Chemical Company under the trade name “Tone” are also useful.

Mixtures of two or more of the foregoing isocyanate-reactive compounds having a functionality of at least 2 and an equivalent weight of at least 200 per isocyanate-reactive group can be used if desired.

The isocyanate-reactive compound(s) may contain dispersed polymer particles. These so-called polymer polyols contain, for example, particles of vinyl polymers such as styrene, acrylonitrile or styrene-acrylonitrile, particles of a polyurea polymer, or polymers of a polyurethane-urea polymer, in each case dispersed in a continuous polyol phase.

In addition, the foregoing isocyanate-reactive compounds can be used in admixture with one or more crosslinkers and/or chain extenders. For purposes of this specification, “crosslinkers” are compounds having at least three isocyanate-reactive groups per molecule and an equivalent weight per isocyanate-reactive group of below 200 grams per mole of isocyanate-reactive groups. “Chain extenders” for purposes of this invention have exactly two isocyanate-reactive groups per molecule and have an equivalent weight per isocyanate-reactive group of below 200 grams per mole of isocyanate-reactive groups. In each case, the isocyanate-reactive groups are preferably hydroxyl, primary amino or secondary amino groups. Crosslinkers and chain extenders preferably have equivalent weights of up to 150 and more preferably up to 125.

Examples of crosslinkers include glycerin, trimethylolpropane, trimethylolethane, diethanolamine, triethanolamine, triisopropanolamine, alkoxylates of any of the foregoing that have equivalent weights of up to 199, and the like. Examples of chain extenders include alkylene glycols (e.g., ethylene glycol, propylene glycol, 1,4-butane diol, 1,6-hexanediol and the like), glycol ethers (such as diethylene glycol, triethylene glycol, dipropylene glycol, tripropylene glycol and the like), ethylene diamine, toluene diamine, diethyltoluene diamine and the like, as well as alkoxylates of any of the foregoing that have equivalent weights of up to 199, and the like.

Crosslinkers and/or chain extenders are typically present in small amounts (if at all). A preferred amount is from 0 to 5 pph of crosslinkers and/or chain extenders. A more preferred amount is from 0.05 to 3 pph and a still more preferred amount is from 0.1 to 2.5 pph of one or more crosslinkers.

Examples of suitable polyisocyanates include, for example, m-phenylene diisocyanate, 2,4- and/or 2,6-toluene diisocyanate (TDI), the various isomers of diphenylmethanediisocyanate (MDI), the so-called polymeric MDI products (which are a mixture of polymethylene polyphenylene polyisocyanates in monomeric MDI), carbodiimide-modified MDI products (such as the so-called “liquid MDI” products which have an isocyanate equivalent weight in the range of 135-170), hexamethylene-1,6-diisocyanate, tetramethylene-1,4-diisocyanate, cyclohexane-1, 4-diisocyanate, hexahydrotoluene diisocyanate, hydrogenated MDI (H12MDI), isophorone diisocyanate, naphthylene-1,5-diisocyanate, methoxyphenyl-2,4-diisocyanate, 4,4′-biphenylene diisocyanate, 3,3′-dimethyoxy-4,4′-biphenyl diisocyanate, 3, 3′-dimethyldiphenyl methane-4,4′-diisocyanate, 4, 4′, 4″-triphenylmethane diisocyanate, hydrogenated polymethylene polyphenylpolyisocyanates, toluene-2,4,6-triisocyanate and 4,4′-dimethyldiphenylmethane-2,2′,5,5′-tetraisocyanate. Any of the foregoing that are modified to contain urethane, urea, uretonimine, biuret, allophonate and/or carbodiimide groups may be used.

Preferred isocyanates include TDI, MDI and/or polymeric MDI, as well as derivatives of MDI and/or polymeric MDI that contain urethane, urea, uretonimine, biuret, allophonate and/or carbodiimide groups. An especially preferred isocyanate is a mixture of TDI and MDI.

The amount of polyisocyanate provided to the foam formulation is expressed as the “isocyanate index”, which is 100 times the ratio of isocyanate groups to isocyanate-reactive groups in the foam formulation. The isocyanate index is typically from about 60 to 150. A preferred isocyanate index is from 60 to 125 and a more preferred isocyanate index is from 65 to 115. In some embodiments, the isocyanate index is from 70 to 115 or from 75 to 115. Water is considered as having two isocyanate-reactive groups.

The blowing agent may be a chemical (exothermic) type, a physical (endothermic) type or a mixture of at least one of each type. Chemical types typically react or decompose to produce carbon dioxide or nitrogen gas under the conditions of the foaming reaction. Water and various carbamate compounds are examples of suitable chemical blowing agents. Physical types include carbon dioxide, various low-boiling hydrocarbons, hydrofluorocarbons, hydroflurochlorocarbons, ethers and the like. Water is most preferred blowing agent, either by itself or in combination with one or more physical blowing agents.

Blowing agents are present in amounts sufficient to provide the desired foam density. When water is the blowing agent, a suitable amount is generally from 1.0 to 7 pph, preferably from 2 to 6 pph.

Suitable surfactants are materials that help to stabilize the cells of the foaming reaction mixture until the materials have cured. A wide variety of silicone surfactants as are commonly used in making polyurethane foams can be used in making the foams with the polymer polyols or dispersions of this invention. Examples of such silicone surfactants are commercially available under the tradenames Tegostab™ (Evonik Corporation), Niax™ (Momentive) and Dabco™ (Evonik Corporation).

Surfactants are typically present in amounts up to 5 pph, more typically 0.1 to 2 pph and preferably 0.25 to 1.5 pph.

Suitable catalysts include those described by U.S. Pat. No. 4,390,645. Representative catalysts include:
(a) tertiary amines, such as trimethylamine, triethylamine, N-methylmorpholine, N-ethylmorpholine, N,N-dimethylbenzylamine, N,N-dimethylethanolamine, N,N, N′, N′-tetramethyl-1,4-butanediamine, N,N-dimethylpiperazine, 1,4-diazobicyclo-2,2,2-octane,bis(dimethylaminoethyl)ether, bis(2-dimethylaminoethyl) ether, morpholine, 4,4′-(oxydi-2,1-ethanediyl)bis, tri(dimethylaminopropyl)amine, pentamethyldiethylenetriamine and triethylenediamine and the like; as well as so-called “low emissive” tertiary amine catalysts that contain one or more isocyanate-reactive groups such as dimethylaminepropylamine and the like;
(b) tertiary phosphines, such as trialkylphosphines and dialkylbenzylphosphines;
(c) chelates of various metals, such as those which can be obtained from acetylacetone, benzoylacetone, trifluoroacetyl acetone, ethyl acetoacetate and the like with metals such as Be, Mg, Zn, Cd, Pd, Ti, Zr, Sn, As, Bi, Cr, Mo, Mn, Fe, Co and Ni;
(d) acidic metal salts of strong acids, such as ferric chloride, stannic chloride, stannous chloride, antimony trichloride, bismuth nitrate and bismuth chloride;
(e) strong bases, such as alkali and alkaline earth metal hydroxides, alkoxides and phenoxides;
(f) alcoholates and phenolates of various metals, such as Ti(OR)₄, Sn(OR)₄ and Al(OR)₃, wherein R is alkyl or aryl, and the reaction products of the alcoholates with carboxylic acids, beta-diketones and 2-(N,N-dialkylamino)alcohols;
(g) salts of organic acids with a variety of metals, such as alkali metals, alkaline earth metals, Al, Sn, Pb, Mn, Co, Ni and Cu including, for example, sodium acetate, stannous octoate, stannous oleate, lead octoate, metallic driers, such as manganese and cobalt naphthenate; and
(h) organometallic derivatives of tetravalent tin, trivalent and pentavalent As, Sb and Bi and metal carbonyls of iron and cobalt.

Catalysts are typically present in small amounts, such as up to 3 pph and generally up to 2 pph. A preferred amount of catalyst is from 0.05 to 2 pph.

The foam can be produced in the presence of additional compounds that reduce aldehyde and/or other emissions in the resulting foam. Among these are aminoalcohol compounds, which are characterized in having at least one primary or secondary amino group and at least one hydroxyl group, each being bonded to an aliphatic carbon atom, and alkylhydroxylamine compounds that include an —NH—OH group wherein the nitrogen atom is bonded to an aliphatic carbon atom.

Aminoalcohol compounds are known and include, for example, those described in US Publication Nos. 2009/0227758 and 2010/0124524, each of which are incorporated herein in their entirety.

In some embodiments, the aminoalcohol or alkylhydroxylamine compound is a compound represented by structure VII:

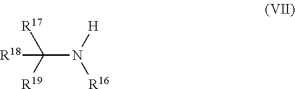

or a salt of such a compound, wherein

R¹⁷, R¹⁸ and R¹⁹ each are independently H, alkyl optionally substituted with phenyl or NR²⁰R²¹ wherein R²⁰ and R²¹ are independently H, C₁-C₆ alkyl, phenyl, or hydroxyalkyl optionally independently substituted with phenyl or NR²⁰R²¹;

R¹⁶ is H, hydroxyl, phenyl, alkyl optionally substituted with phenyl or NR²⁰R²⁰, or

hydroxyalkyl optionally independently substituted with phenyl or NR²⁰R²¹, provided that when none of R¹⁷, R¹⁸ and R¹⁹ are hydroxyalkyl, then R¹⁶ is hydroxyl or hydroxyalkyl optionally independently substituted with phenyl or another NR²⁰R²¹.

The aminoalcohol or alkylhydroxylamine preferably has a molecular weight of no greater than 500 grams/mole.

Specific examples of suitable aminoalcohols are 2-amino-1-butanol, 2-amino-2-ethyl-1,3-propanediol, 2-amino-2-methyl-1-propanol, 2-amino-1-methyl-1,3-propanediol, 1,1,1-tris (hydroxymethyl) methylamine, ethanolamine, diethanolamine, N-methylethanolamine, N-butylethanolamine, monoisopropanolamine, 2 -amino-2(hydroxymethyl)propane-1,3-diol. diisopropanolamine, mono-sec-butanolamine, di-sec-butanolamine, or salts thereof. These aminoalcohols are available from a variety of commercial sources, including ANGUS Chemical Company (Buffalo Grove, Ill., USA), The Dow Chemical Company (Midland, Mich., USA), or can be readily prepared by techniques well known in the art. The aminoalcohols can be used in the form of salts. Suitable salts include hydrochloride, acetate, formate, oxalate, citrate, carbonate, sulfate, and phosphate salts.

Specific examples of alkylhydroxylamines include N-isopropylhydroxylamine, N-ethylhydroxylamine, N-methylhydroxylamine, N-(n-butyl)hydroxylamine, N-(sec-butyl)hydroxylamine and the like.

The foam may be produced in the presence of at least one antioxidant. Examples of suitable antioxidants include phenolic compounds, aminic antioxidants, thiosynergists such as dilauryl thiodipropionate or distearyl thiodipropionate, phosphites and phosphonites, benzofuranones and indolinones such as those disclosed in U.S. Pat. Nos. 4,325,863; 4,338,244; 5,175,312; 5,216,052; 5,252,643; DE-A-4316611; DE-A-4316622; DE-A-4316876; EP-A-0589839 or EP-A-0591102; tocophenols, hydroxylated thiodiphenyl ethers, O-, N- and S-benzyl compounds, hydroxybenzylated malonates, triazine compounds, benzylphosphonates, acylaminophenols, amides of β-(3,5-di-tert-butyl-4-hydroxyphenyl)propionic acid, ascorbic acid (vitamin C), 2-(2′-hydroxyphenyl)benzotriazoles, 2-hydroxybenzophenones, esters of substituted and unsubstituted benzoic acids, acrylates, nickel compounds, oxamides, 2-(2-hydroxyphenyl)-1,3,5-triazines, hydroxylamines, nitrones, esters of β-thiodipropionic acid, as described, for example, in U.S. Pat. No. 6,881,774, incorporated herein by reference.

The antioxidant(s), when used, are present in an effective amount, such as up to about 10 pph. A preferred amount is from 0.1 to 5 pph, and a more preferred amount is from 0.2 to 1.5 pph. In some embodiments, a HALS (hindered amine light stabilizer) compound is present. Suitable HALS compounds include bis(1-octyloxy)-2,2,5,5-tetramethyl piperidinyl) sebacate (Tinuvin™ 123 from BASF), n-butyl-(3,5-di-tert-butyl-4-hydroxylbenzyl)bis-(1,2,2,6-pentamethyl-4-piperidinyl)malonate (Tinuvin™ 144 from BASF), dimethyl succinate polymer with 4 -hydroxy-2-2,6,6-tetramethyl-1-piperidinethanol (Tinuvin™ 622 from BASF), bis(1,2,2,6,6-pentamethyl-4-piperidinyl) sebacate (Tinuvin™ 765 from BASF) and bis(2,2,6,6-tetramethyl-4-piperidinyl) sebacate (Tinuvin™ 770 from BASF) and the like.

The HALS compound, when used, is present in an effective amount, such as up to about 10 pph. A preferred amount is from 0.1 to 5 pph, and a more preferred amount is from 0.1 to 2.5 pph.

Other ingredients may be present during the foaming step, including, for example, fillers, colorants, odor masks, flame-retardants, biocides, antistatic agents, thixotropic agents and cell openers.

Polyurethane foam is made in accordance with this invention by forming a reaction mixture containing the various ingredients and curing the reaction mixture. Free-rise processes such as continuous slabstock production methods can be used. Alternatively, molding methods can be used. Such processes are well known. Generally, no alternation of conventional processing operations is needed to produce polyurethane foam in accordance with this invention (other than the inclusion of the β-diketone compound of structure I and the water-soluble amino-functional polymer).

The various ingredients may be introduced individually or in various subcombinations into a mixhead or other mixing device where they are mixed and dispensed into a region (such as a trough or other open container, or a closed mold) where they are cured. It is often convenient, especially when making molded foam, to form a formulated polyol component that contains the isocyanate-reactive compound(s), including crosslinkers and/or chain extenders as may be used, the β-diketone compound of structure I, the water-soluble amino-functional polymer, other additives (if present) and optionally the catalyst(s), surfactant(s) and blowing agent(s). This formulated polyol component is then contacted with the polyisocyanate (as well as any other ingredients that are not present in the formulated polyol component) to produce the foam.

Some or all of the various components may be heated prior to mixing them to form the reaction mixture. In other cases, the components are mixed at approximately ambient temperatures (such as from 15-40° C.). Heat may be applied to the reaction mixture after all ingredients have been mixed, but this is often unnecessary.

The product of the curing reaction is a flexible polyurethane foam. The foam density may be from 20 to 200 kg/m³. For most seating and bedding applications, a preferred density is from 24 to 80 kg/m³. The foam may have a resiliency of at least 50% on the ball rebound test of ASTM 3574-H. Foam produced in accordance with this invention is useful, for example, in cushioning applications such as bedding and domestic, office or vehicular seating, as well as in other vehicular applications such as headrests, dashboards instrument panels, armrests, headliners, noise, vibration and harshness (NVH) abatement foam, and acoustical foam.

Polyurethane foams made in accordance with the invention are characterized in having reduced emissions of aldehydes, in particular one or more of formaldehyde, acetaldehyde, acrolein and propionaldehyde, compared to the case in which the 3β-diketone compound compound of structure I and the water-soluble amino-functional polymer are absent. A suitable method for measuring formaldehyde, acetaldehyde, acrolein and propionaldehyde emissions is as follows: The polyurethane foam sample is crushed to open the cells. The crushed foam is cut into cubic 10 cm×10 cm×14 cm samples, which are immediately packaged tightly in aluminum foil or polyethylene film and kept in this manner for 5 days at about 25° C.

Aldehyde concentrations are measured according to the Toyota TSM0508G test method. In that Toyota method, the foam sample is removed from the foil or film and then placed in individual 10 L Tedlar gas bags (Delin Co., Ltd., China) that have previously been purged three times with nitrogen gas. The bag with the foam sample is filled with 7 L of nitrogen, sealed and heated 65° C. for two hours. The plastic bag containing the foams is removed from the oven. The gas in the bag is pumped through a 350 mg dinitrophenylhydrazine cartridge to capture the carbonyl compounds. The captured carbonyl compounds are analyzed for formaldehyde, acetaldehyde, acrolein and propionaldehyde by liquid chromatography, with results being expressed in terms of weight of the respective aldehyde per cubic meter of gas in the gas bag. Details for a specific method of performing the Toyota test method are described in the following examples.

The amount of emitted formaldehyde, acetaldehyde, acrolein and propionaldehyde as determined in this method are all typically at least 10% reduced as compared to an otherwise like foam that is produced in the absence of the β-diketone compound and water-soluble amino-functional polymer. An advantage of this invention is that significant reductions are seen in the emitted amounts of some or even all of these aldehyde compounds. Reductions in emitted formaldehyde may exceed 70% or 75%; reductions in acetaldehyde may exceed 40% or exceed 50%, reductions in acrolein may exceed 70%, exceed 80% or even exceed 90%.

In some embodiments, the amount of emitted formaldehyde is no greater than 100 μg/m³, no greater than 75 μg/m³ or no greater than 50 μg/m³, as measured according to the Toyota method. In some embodiments, the amount of emitted acetaldehyde is no greater than 100 μg/m³, as measured according to Toyota method. In some embodiments, the amount of emitted acrolein is no greater than 100 μg/m³ or no greater than 60 μg/m³, as measured according to the Toyota method. In some embodiments, the amount of emitted propionaldehyde is no greater than 350 μg/m³ or no greater than 250 μg/m³, as measured according to the Toyota method.

The following examples are provided to illustrate the invention, but are not intended to limit the scope thereof. All parts and percentages are by weight unless otherwise indicated.

### EXAMPLE 1 AND COMPARATIVE SAMPLES A-C

General Foaming Method, Comparative Sample A: A formulated polyol is made by combining 40 parts of a nominally trifunctional polyether polyol having a hydroxyl number of 29.5, 52.6 parts of a 1700 equivalent weight polyether polyol initiated from a mixture of sucrose and glycerine, 0.8 part of glycerin, 1.6 parts of a urethane catalyst mixture, 0.5 parts of an organosilicone foam-stabilizing surfactant and 4.2 parts of water. Polyurethane foams are made from the formulated polyol by combining the formulated polyol with an isocyanate-terminated prepolymer at a 1.67:1 weight ratio, pouring the resulting reaction mixture into a cup and allowing the reaction mixture to rise and cure to form a polyurethane foam. After the foam has cured enough to be dimensionally stable, it is removed from the cup and, except for Comparative Samples B and C, 10 cm×10 cm×14 cm samples, weighing about 38 to 41 grams are cut. For Comparative Samples B and C, 30 gram samples are cut. The foam cubes each are immediately wrapped in aluminum foil to form an air-tight package for 7 days.

Comparative Samples B and C are made using the general foaming method. In Comparative Sample B, a 600 MW polyethylene imine (PEI) (0.05% based on formulated polyol weight, 0.054% based on isocyanate reactive materials of 200 g/mol or greater equivalent weight) is added to the formulated polyol before making the foam. In Comparative Sample B, N-(2-hydroxyethyl)acetoacetamide N-AAEM) (0.1% based on formulated polyol weight, 0.108% based on isocyanate reactive materials of 200 g/mol or greater equivalent weight) is added to the formulated polyol before making the foam.

Example 1 is made in using the general foaming method. In Example 1, both the 600 MW PEI (0.05% based on formulated polyol weight, 0.054% based on isocyanate reactive materials of 200 g/mol or greater equivalent weight) and N-AAEM (0.1% based on formulated polyol weight, 0.108% based on isocyanate reactive materials of 200 g/mol or greater equivalent weight) are added to the formulated polyol before making the foam.

Aldehydes emitted from the foam samples are analyzed using the Toyota gas bag method. The cubed foam samples are in each case removed from the foil and put into a 10 L Tedlar gas bag that has been washed with pure nitrogen three times and emptied. An empty gas bag is used as a blank. After the foam sample is put into the gas bag, the bag is filled with about 7 L of nitrogen gas and heated in the oven for 2 hours at 65° C. The nitrogen gas in the gas bag is then pumped out by an air pump and analyzed for formaldehyde, acetaldehyde, acrolein and propionaldehyde.

The gas from each bag is passed through a dinitrophenylhydrazine (DNPH) cartridge (CNWBOND DNPH-Silica cartridge, 350 mg, Cat. No. SEEQ-144102, Anple Co., Ltd.) at a sampling speed is 330 mL/min The aldehydes emitted from the foam into the gas are absorbed by the cartridge to form DNPH derivatives. The DNPH cartridge is eluted with 3 g of acetonitrile, and the resulting acetonitrile solution is analyzed by HPLC to quantify the carbonyls in the sample, as follows.

A standard solution containing 15 μg/mL each of formaldehyde, acetaldehyde, acrolein and propionaldehyde (in each case in the form of DNPH derivatives) (TO11A carbonyl-DNPH mix, Cat. No. 48149-U, Supelco Co., Ltd) is diluted with acetonitrile. A vial containing 2 mL of the diluted solution (containing 0.794 ppm of each of formaldehyde, acetaldehyde, acrolein and propionaldehyde) is refrigerated to −4° C. The refrigerated solution is injected into the HPLC system and analyzed for formaldehyde, acetaldehyde, acrolein and propionaldehyde derivatives. The response factor is calculated from the area of the elution peak for each derivative, according the formula:

$$Response factor i = \frac{Peak Area i}{0.794}$$

where Response factor i=Response factor of derivative i; Peak Area i=Peak Area of derivative i in standard solution and 0.794=the concentration of each derivative in the standard solution.

The amounts of formaldehyde, acetaldehyde, acrolein, and propionaldehyde emitted by each foam sample are then determined. In each case, the acetonitrile solution obtained by eluting the DNPH column is injected into the HPLC system and the area of the elution peak is determined from each derivative. The concentration of the aldehyde-DNPH derivative in the sample solution is calculated as follows:

$$Concentration of i = \frac{Peak Area i}{Response factor i}$$

where: Concentration of i=Concentration of aldehyde—DNPH derivative in the sample solution, Peak Area i=Peak Area of Derivative i in sample solution and Response factor i=Response factor of derivative i, determined from the standard solutions as described above.

The HPLC conditions are as follows:

| Instrument: | Agilent 1200 HPLC | | | |
|---|---|---|---|---|
| Column: | Supelco Ascentis Express C18, 15 cm*4.6 mm, 2.7 um | | | |
| Mobile Phase: | Solvent A: 0.1% H₃PO₄ in Acetonitrile | | | |
| | Solvent B: 0.1% H₃PO₄ in DI water | | | |
| Column Oven: | 15° C. | | | |
| Detection: | DAD detector at 360 nm | | | |
| Gradient: | Time (mn) | % A | % B | Flow (mL/min) |
| | 0 | 45 | 55 | 1 |
| | 7 | 45 | 55 | 1 |
| | 14 | 50 | 50 | 1 |
| | 20 | 85 | 15 | 1 |
| | 25 | 100 | 0 | 1 |

| | |
|---|---|
| Equilibration | 5 min |
| Time: | |
| Injection: | 10 uL |

The concentrations of formaldehyde, acetaldehyde acrolein and propionaldehyde for each of Example 1 and Comparative Samples A-C are as indicated in Table 1.

TABLE 1

| | | Comp. B* | Comp. C* | Ex. 1 |
|---|---|---|---|---|
| Sample | Comp. A* | 0.054% | 0.108% | 0.054% PEI + |
| Additives | None | PEI | N-AAEM | 0.108% N-AAEM |
| Formaldehyde, | 397 | 413 | 101 | 65 |
| μg/m³ | | | | |
| Acetaldehyde, | 217 | 374 | 237 | 97 |
| μg/m³ | | | | |
| Acrolein, | 1061 | 937 | 167 | 54 |
| μg/m³ | | | | |
| Propionaldehyde, | 362 | 613 | 769 | 315 |
| μg/m³ | | | | |

*Not an example of this invention.

As the data in Table 1 shows, PEI by itself provides no benefit in reducing the levels of any of the aldehydes tested. N-AAEM is effective only for reducing formaldehyde and acrolein. The combination of PEI and N-AAEM leads to large reductions in all four aldehydes tested, in each case to levels much lower than are achieved using either PEI or N-AAEM by itself. These results are quite surprising given that PEI by itself in provides very little benefit; combining it with N-AAEM would not be expected to lead to any better performance than that of N-AAEM by itself.

### EXAMPLE 2 AND COMPARATIVE SAMPLES D-F

Comparative Sample D is a repeat of Comparative Sample A.

Comparative Samples E and F are made using the general foaming method. In Comparative Sample E, 0.05% of the 600 MW polyethylene imine (PEI) (0.05% based on formulated polyol weight, 0.054% based on isocyanate reactive materials of 200 g/mol or greater equivalent weight)) is added to the formulated polyol before making the foam. In Comparative Sample F, (acetoacetoxy)ethyl methacrylate (AAEM) (0.1% based on formulated polyol weight, 0.108% based on isocyanate reactive materials of 200 g/mol or greater equivalent weight) is added to the formulated polyol before making the foam.

Example 2 is made in using the general foaming method. In Example 2, both the 600 MW PEI (0.05% based on formulated polyol weight, 0.054% based on isocyanate reactive materials of 200 g/mol or greater equivalent weight) and AAEM (0.1% based on formulated polyol weight, 0.108% based on isocyanate reactive materials of 200 g/mol or greater equivalent weight) are added to the formulated polyol before making the foam.

The foams are tested as indicated in the previous examples. Results are as indicated in Table 2.

TABLE 2

| | | Comp. E* | Comp. F* | Ex. 1 |
|---|---|---|---|---|
| Sample | Comp. D* | 0.054% | 0.108% | 0.054% PEI + |
| Additives | None | PEI | AAEM | 0.108% AAEM |
| Formaldehyde, | 400 | 306 | 39 | 29 |
| μg/m³ | | | | |
| Acetaldehyde, | 189 | 207 | 155 | 90 |
| μg/m³ | | | | |
| Acrolein, | 736 | 541 | 158 | 38 |
| μg/m³ | | | | |
| Propionaldehyde, | 478 | 495 | 476 | 245 |
| μg/m³ | | | | |

*Not an example of this invention.

In this set of experiments, PEI by itself provides benefit in reducing the acrolein level, but not that of any of the other aldehydes. AAEM by itself moderately reduces the formaldehyde, acetaldehyde and acrolein emissions, but not propionaldehyde emissions. The combination of PEI and AAEM leads to large reductions in all four aldehydes tested, in each case to levels much lower than are achieved using either PEI or N-AAEM by itself. Again, these results are quite surprising given that PEI by itself in provides very little benefit.

1. A process for producing a polyurethane foam comprising forming a reaction mixture that contains an aromatic polyisocyanate, at least one isocyanate-reactive material having an average functionality of at least 2 and an equivalent weight of at least 200 grams per mole of isocyanate-reactive groups, at least one blowing agent, at least one surfactant and at least one catalyst, and curing the reaction mixture to form the polyurethane foam, wherein the curing step is performed in the presence of (i) at least one β-diketone compound, wherein the β-diketone compound is a compound represented by structure I: 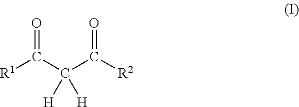
wherein R¹ and R² are independently selected from hydrogen, —NH₂, —NH—R³—N(R⁴)₂, —OR⁴ and —R⁴, wherein each R³ and R⁴ is independently unsubstituted hydrocarbon or hydrocarbon substituted with one or more of O, N, S, P or halogen, with the proviso that R¹ and R² together may form a divalent radical and further provided that at least one of R¹ and R² is not hydrogen, and (ii) at least one water-soluble, amino-functional polymer having a number average molecular weight of at least 300 and at least 3 primary and/or secondary amino groups per molecule.

2. A process for reducing aldehyde emissions from a polyurethane foam, comprising: a) combining
(i) at least one β-diketone compound is a compound represented by structure I: 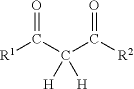
wherein R¹ and R² are independently selected from hydrogen, —NH₂, —NH—R³—N(R⁴)₂, —OR⁴ and —R⁴, wherein each R³ and R⁴ is independently unsubstituted hydrocarbon or hydrocarbon substituted with one or more of O, N, S, P or halogen, with the proviso that R¹ and R₂ together may form a divalent radical and further provided that at least one of R¹ and R² is not hydrogen, and
(ii) at least one water-soluble, amino-functional polymer having a number average molecular weight of at least 300 and at least 3 primary and/or secondary amino groups per molecule,
with at least one isocyanate-reactive material having an average functionality of at least 2 and an equivalent weight of at least 200 grams per mole of isocyanate-reactive groups to form a mixture and then b) combining the mixture from step a) with at least one organic polyisocyanate and curing the resulting reaction mixture in the presence of at least one blowing agent, at least one surfactant and at least one catalyst to form a polyurethane foam.

3. The process of claim 1 wherein the β-diketone compound is an acetoacetate ester or amide is characterized by having one or more acetoacetate ester or acetoacetate amide groups having structure II: 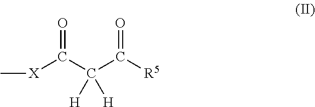
wherein R⁵ is a substituted or unsubstituted C₁-C₆ alkyl or a substituted or unsubstituted aryl group, and X is —O— in the case of an ester and —NH— in the case of an amide.

4. The process of claim 3 wherein the β-diketone compound is N-(2-hydroethyl)acetoacetamide or (acetoacetoxy)ethyl methacrylate.

5. The process of claim 1 wherein the the β-diketone compound is a 3-oxopropanamide compound represented by structure IV: 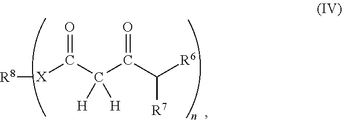
wherein R⁸ is hydrogen or a hydrocarbon group, R⁶ is hydrogen, hydrocarbon, hydroxyalkyl or aminoalkyl, R⁷ is hydroxyalkyl or aminoalkyl, and n is at least 1.

6. The process of claim 1 wherein the β-diketone compound is represented by the structure 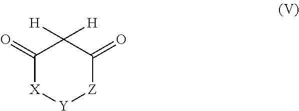
wherein X, Y, Z are independently carbonyl, —C(R⁹R¹⁰)—, —NR¹¹—, —O— or a chemical bond, each R⁹ and R¹⁰ are independently H, a substituted or unsubstituted linear or branched alkyl or alkylene group having 1 to 10 carbon atoms, a substituted or unsubstituted phenyl group, a halogen, —CO₂CH₃, or —CN, with the proviso that any two or more of R⁹ and R¹⁰ may be connected intra- or inter-molecularly and each R¹¹is independently H, a substituted or unsubstituted linear or branched alkyl or alkylene group having 1 to 10 carbon atoms or a substituted or unsubstituted phenyl group.

7. The process of claim 1 wherein the water-soluble, amino-functional polymer is a polyethyleneimine.

8. A polyurethane foam made in the process of claim 1.

9. A process for reducing aldehyde emissions from a polyether polyol, comprising combining 0.01 to 5 parts by weight of at least one β-diketone compound and 0.01 to 5 parts by weight of at least one water-soluble, amino-functional polymer having a number average molecular weight of at least 300 and at least 3 primary and/or secondary amino groups per molecule with 100 parts by weight of the polyether polyol, wherein the β-diketone compound is represented by structure I: 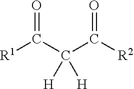
wherein R¹ and R² are independently selected from hydrogen, —NH₂, —NH—R³—N(R⁴)₂, —OR⁴ and —R⁴, wherein each R³ and R⁴ is independently unsubstituted hydrocarbon or hydrocarbon substituted with one or more of O, N, S, P or halogen, with the proviso that R¹ and R² together may form a divalent radical and further provided that at least one of R¹ and R² is not hydrogen.

10. The process of claim 9 wherein the β-diketone compound is an acetoacetate ester or amide is characterized by having one or more acetoacetate ester or acetoacetate amide groups having structure II: 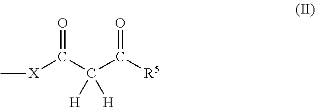
wherein R⁵ is a substituted or unsubstituted C₁-C₆ alkyl or a substituted or unsubstituted aryl group, and X is —O— in the case of an ester and —NH— in the case of an amide.

11. The process of claim 10 wherein the β-diketone compound is N-(2-hydroethyl)acetoacetamide or (acetoacetoxy)ethyl methacrylate.

12. The process of claim 9 wherein the the β-diketone compound is a 3-oxopropanamide compound represented by structure IV: 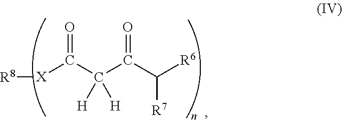
wherein R⁸ is hydrogen or a hydrocarbon group, R⁶ is hydrogen, hydrocarbon, hydroxyalkyl or aminoalkyl, R⁷ is hydroxyalkyl or aminoalkyl, and n is at least 1.

13. The process of claim 9 wherein the β-diketone compound is represented by the structure 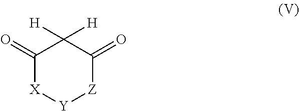
wherein X, Y, Z are independently carbonyl, —C(R⁹R¹⁰)—, —NR¹¹—, —O— or a chemical bond, each R⁹ and R¹⁰ are independently H, a substituted or unsubstituted linear or branched alkyl or alkylene group having 1 to 10 carbon atoms, a substituted or unsubstituted phenyl group, a halogen, —CO₂CH₃, or —CN, with the proviso that any two or more of R⁹ and R¹⁰ may be connected intra- or inter-molecularly and each R¹¹ is independently H, a substituted or unsubstituted linear or branched alkyl or alkylene group having 1 to 10 carbon atoms or a substituted or unsubstituted phenyl group.

14. The process of claim 9 wherein the water-soluble, amino-functional polymer is a polyethyleneimine.

15. A polyether polyol having a hydroxyl equivalent weight of at least 200 grams per equivalent of hydroxyl groups, which polyether polyol contains 0.01 to 5 parts by weight of at least one β-diketone compound and 0.01 to 5 parts by weight of at least one water-soluble, amino-functional polymer having a number average molecular weight of at least 300 and at least 3 primary and/or secondary amino groups per molecule with 100 parts by weight of the polyether polyol, wherein the β-diketone compound is represented by structure I: 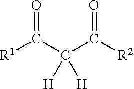
wherein R¹ and R² are independently selected from hydrogen, —NH₂, —NH—R³—N(R⁴)₂, —OR⁴ and —R⁴, wherein each R³ and R⁴ is independently unsubstituted hydrocarbon or hydrocarbon substituted with one or more of O, N, S, P or halogen, with the proviso that R¹ and R² together may form a divalent radical and further provided that at least one of R¹ and R² is not hydrogen.
